(19) United States
(12) Patent Application Publication
(10) Pub. No.: US 2009/0161509 A1
(43) Pub. Date: Jun. 25, 2009

(54) OPTICAL DISC DISCRIMINATING DEVICE, REPRODUCING DEVICE, OPTICAL DISC DISCRIMINATING METHOD, OPTICAL DISC DISCRIMINATING PROGRAM AND RECORDING MEDIUM

(75) Inventor: Yoshimichi Nishio, Saitama (JP)

Correspondence Address: SUGHRUE MION, PLLC, 2100 PENNSYLVANIA AVENUE, N.W., SUITE 800, WASHINGTON, DC, 20037, US

(73) Assignee: PIONEER CORPORATION, Meguro-ku, Tokyo (JP)

(21) Appl. No.: 12/090,391

(22) PCT Filed: Sep. 28, 2006
(86) PCT No.: PCT/JP2006/319291

§ 371 Date: Apr. 16, 2008

(30) Foreign Application Priority Data
Oct. 19, 2005 (JP) 2005-303917

(51) Int. Cl. G11B 7/00

(52) U.S. Cl. 369/47.15; G9B/7

(57) ABSTRACT

[Problems] To accurately and speedily perform discrimination of a plurality of kinds of optical discs by an optical disc discriminating device.

[Means for Solving Problems] At the time of discriminating CD, DVD and Blu-ray Disc, a laser beam is applied from a laser diode for CD to an optical disc to be discriminated, a focus error signal level and an AS signal level are measured from the reflecting light, and discrimination of three kinds is performed by the results, based on previously set first threshold values (Vfe1, Vas1), second threshold values (Vfe2, Vas2) and a ratio (Vfeas1) of the focus error signal level to the AS signal level as a third threshold value. When the disc is not discriminated as CD or DVD or Blu-ray Disc by using the laser diode for CD, the laser diode is switched to a laser diode for Blu-ray Disc to apply a laser beam, the focus error signal level and the AS signal level are measured from the reflecting light, and the disc is discriminated based on third threshold values (Vfe3, Vas3).

### TECHNICAL FIELD

This invention relates to an optical disc discriminating device for discriminating a plurality of types of optical discs, a reproducing device having the optical disc discriminating device, an optical disc discriminating method, an optical disc discriminating program, and a recording medium storing the optical disc discriminating program.

### BACKGROUND

A conventional optical disc discriminating device discriminates the types of the optical discs with a single laser oscillator based on a focus error signal or an RF signal from a reflected light of a laser beam applied to the optical discs.

For example, Patent Document 1 discloses a method for discriminating between a digital video disc (DVD) and a compact disc (CD) based on a focus error signal, a track error signal, and an RF signal with a semiconductor laser (laser oscillator) for the digital video disc.

[Patent Document 1] Japanese Patent No. 3203183

### DISCLOSURE OF THE INVENTION

### Problem to be Solved by the Invention

The method disclosed in patent Document 1 only can discriminate between two types of optical discs. For example, when three types, CD, DVD, and Blu-ray disc (BD) of optical discs are tried to be discriminated from each other with the semiconductor laser having CD wavelength, the Blu-ray disc may reflect the laser beam having the CD wavelength over a supposed reflection owing to manufacturing dispersion of the Blu-ray disc, and may be misclassified as the CD or the DVD with a conventional specific threshold value. Further, when a new threshold value for the BD is set, the CD or the DVD having low reflectivity may be misclassified as not being the CD or the DVD.

Further, it is difficult to discriminate between layers of a disc having layers for recording and reproducing with semiconductor lasers having different wavelengths such as a hybrid disc of the DVD and the BD due to the above-described problem.

Accordingly, an object of the present invention is to provide an optical disc discriminating device, an optical disc discriminating method, an optical disc discriminating program, and a reproducing device having a recording medium and the optical disc discriminating device, wherein the optical disc discriminating device can correctly and rapidly discriminate a type of an optical disc from more than two types of optical discs or a layer of a hybrid disc having more than one layer overlapped with each other.

### Means for Solving Problem

For attaining the object, according to claim 1 of the present invention, there is provided an optical disc discriminating device for discriminating a plurality of types of optical discs comprising:

a plurality of laser oscillators having different wavelengths corresponding to the types of optical discs,

a measuring device for measuring a reflected light signal of a laser beam applied to an optical disc by any one of the laser oscillators,

a discriminating device for discriminating the type of the optical disc from among the types of the optical discs, or judging unable to discriminate based on the signal measured by the measuring device, and

a controlling device to make the discriminating device perform said discrimination or said judgment,

wherein when the discriminating device judges unable to discriminate, the controlling device makes another laser oscillator different from the one oscillator apply a laser beam to the optical disc, and makes the discriminating device perform the discrimination or the judgment.

According to claim 11 of the present invention, there is provided an optical disc discriminating method for discriminating a plurality of types of optical discs comprising:

a discriminating step of discriminating a type of the optical disc from among a plurality of types of the optical disc based on a reflected light signal of a laser beam applied from any one of a plurality of laser oscillators having different wavelengths to the optical disc, or judging unable to discriminate the type of the optical disc; and

a re-discriminating step of performing said discrimination or said judgment based on a reflected light signal of a laser beam applied from another laser oscillator different from the one laser oscillator.

### BRIEF DESCRIPTION OF DRAWINGS

FIG. 1 A block diagram showing a multi disc player according to first and second embodiments of the present invention.

FIG. 2 An explanatory view showing a photo detector of an optical pickup in the multi disc player shown in FIG. 1.

FIG. 3A An explanatory view showing a waveform of a focus error signal.

FIG. 3B An explanatory view showing a waveform of an AS signal.

FIG. 4A An explanatory view showing first and second threshold values.

FIG. 4B An explanatory view showing a third threshold value.

FIG. 5 A flowchart showing a discriminating operation of an optical disc according to the first embodiment of the multi disc player shown in FIG. 1.

FIG. 6 A part of the flowchart showing a discriminating operation of an optical disc according to the second embodiment of the multi disc player shown in FIG. 1.

FIG. 7 The other parts of the flowchart showing the discriminating operation of an optical disc according to the second embodiment of the multi disc player shown in FIG. 1.

### EXPLANATIONS OF LETTERS OR NUMERALS

1 multi disc player (optical disc discriminating device, reproducing device)
3 optical pickup (laser oscillator)
5 servo signal processing member (measuring device, discriminating device, controlling device, regulating device)
7 audio-visual signal processing member (reproducing device)
12 optical disc
S101 measuring with a laser diode having CD wavelength (measuring device)
S102 discriminating CD (discriminating device, discriminating step)
S103 discriminating DVD (discriminating device, discriminating step)
S104 discriminating BD (discriminating device, discriminating step)
S105 measuring with a laser diode having BD wavelength (measuring device)
S106 discriminating BD (discriminating device, re-discriminating step)
S107 discriminating CD (discriminating device, discriminating step)
S108 discriminating DVD (discriminating device, discriminating step)
S201 measuring with a laser diode having DVD wavelength (measuring device)
S202 discriminating DVD layer (discriminating device, discriminating step)
S204 discriminating CD layer (discriminating device, discriminating step)
S206 discriminating BD layer (discriminating device, discriminating step)
S209 measuring with a laser diode having BD wavelength (measuring device)
S210 discriminating BD layer (discriminating device, re-discriminating step)
S212 discriminating DVD layer (discriminating device, discriminating step)
S214 discriminating CD layer (discriminating device, discriminating step)
S220 regulating recording and reproducing operations (regulating device)
S221 recording and reproducing only a discriminated layer (regulating device)
Vfecd focus error signal level measured with the laser diode having the CD wavelength (reflected light signal)
Vascd AS signal level measured with the laser diode having the CD wavelength (reflected light signal)
Vfeascd Ratio of Vfecd to Vased (ratio of one signal to another signal)
Vfebd focus error signal level measured with the laser diode having the BD wavelength (reflected light signal)
Vasbd AS signal level measured with the laser diode having the BD wavelength (reflected light signal)
Vfe1 first threshold value of the focus error signal level measured with the laser diode having the CD wavelength (first threshold value)
Vfe2 second threshold value of the focus error signal level measured with the laser diode having the CD wavelength (second threshold value)
Vfe3 third threshold value of the focus error signal level measured with the laser diode having the BD wavelength (third threshold value)
Vas1 first threshold value of the AS signal level measured with the laser diode having the CD wavelength (first threshold value)
Vas2 second threshold value of the AS signal level measured with the laser diode having the CD wavelength (second threshold value)
Vas3 third threshold value of the AS signal level measured with the laser diode having the BD wavelength (third threshold value)
Vfedvd focus error signal level measured with the laser diode having the DVD wavelength (reflected light signal)
Vasdvd AS signal level measured with the laser diode having the DVD wavelength (reflected light signal)
Vfeasdvd Ratio of Vfedvd to Vasdvd (ratio of one signal to another signal)
Vfebd′ focus error signal level measured with the laser diode having the BD wavelength (reflected light signal)
Vasbd′ AS signal level measured with the laser diode having the BD wavelength (reflected light signal)
Vfe1′ first threshold value of the focus error signal level measured with the laser diode having the DVD wavelength (first threshold value)
Vfe2′ second threshold value of the focus error signal level measured with the laser diode having the DVD wavelength (second threshold value)
Vfe3′ third threshold value of the focus error signal level measured with the laser diode having the BD wavelength (third threshold value)
Vas1′ first threshold value of the AS signal level measured with the laser diode having the DVD wavelength (first threshold value)
Vas2′ second threshold value of the AS signal level measured with the laser diode having the DVD wavelength (second threshold value)
Vas3′ third threshold value of the AS signal level measured with the laser diode having the BD wavelength (third threshold value)

### BEST MODE FOR CARRYING OUT THE INVENTION

Hereafter, an optical disc discriminating device according to a first embodiment of the present invention will be explained. In the optical disc discriminating device, a measuring device measure a reflected light signal of a laser beam applied to an optical disc by any one of laser oscillators having different wavelengths, a discriminating member discriminates a type of the optical disc from among types of optical discs, or judges unable to discriminate based on the measured signal by the measuring device, and a controlling device makes the discriminating device perform the discrimination or the judgment. Further, when the discriminating device judges unable to discriminate, the controlling device makes the discriminating device perform the discrimination or the judgment using another laser oscillator different from the one oscillator. Thus, when the optical disc is discriminated with the first laser oscillator, only one laser oscillator can be used. Even when the optical disc is not discriminated with the first laser oscillator, the optical disc is discriminated with one of the other laser oscillator. Therefore, this discrimination is faster than discrimination with sequential applications of laser oscillators corresponding to respective optical discs.

Further, the measuring device may measure signals of a plurality of types from the reflected light, and the discriminating device performs the discrimination or the judgment based on the types of signals and a ratio of one type to the other type among the types of signals. Thus, if it is difficult to discriminate the type of the optical disc with only one signal, the discriminating device can discriminate the type of the optical disc using such as a signal level difference between the signals generated corresponding to the types of the optical discs.

Further, when reflected light signal ranges or the reflected light signal ratio ranges by applying the laser beam to any one of the optical discs by the one laser oscillator and by applying the laser beam to another optical disc different from the one optical disc by the one laser oscillator are overlapped, the controlling device may previously store a first threshold value corresponding to an upper limit of an overlapped range, and a second threshold value corresponding to a lower limit of the overlapped range, and when the ranges are not overlapped with each other, the controlling device may previously store a third threshold value to be used for discriminating the reflected light ranges. Further, the controlling device may make the discriminating device discriminate or judge using the first, second, and third threshold values. Thus, when the ranges are overlapped with each other, the types of the optical discs are discriminated or judged unable to be discriminated using the first and second threshold values, and when the ranges are not overlapped with each other, the types of the same are discriminated or judged unable to be discriminated using the third threshold value. Therefore, the types of the optical discs can be correctly discriminated or judged unable to be discriminated.

Further, the discriminating device may discriminate the one type from the other types of the optical discs based on the reflected light signals or the ratios when either the reflected light signals or the ratios measured by the measuring device upon an application of the laser beam from the one laser oscillator are not in the overlapped range. Thus, when the reflected light signals and the ratios are not in the overlapped range, the types of the optical discs can be correctly discriminated.

Further, the discriminating device judges unable to discriminate the type of the measured optical disc when all the reflected light signals and the ratios measured by the measuring device upon an application of the laser beam from the one laser oscillator is in the overlapped range. Thus, when the reflected light signals and the ratios are in the overlapped range, misjudgments can be reduced.

Further, the signals of a plurality of types may at least include a focus error signal and a total returned light signal. Thus, because the focus error signal and the total returned light signal may be in different levels depending on the optical discs, the discrimination or the judgment of the optical discs can be correctly performed.

Further, a plurality of reproducible regions which are to be reproduced by respective laser oscillators are overlapped with each other on the optical disc, and the controlling device may make the one laser oscillator apply the laser beam to the regions of respective layers of the optical disc, and make the discriminating device discriminate or judge the types of the respective layers based on the reflected light signals from the respective layers. Thus, the optical discs having a plurality of layers overlapped with each other can be rapidly and correctly discriminated.

Further, a reproducing device for at least reproducing data of the optical discs of a plurality of types may further includes the optical disc discriminating device. Thus, the reproducing device can rapidly and correctly discriminate the type of a mounted optical disc and reproduce the data of the optical disc.

The reproducing device may further include a regulating device to make the reproducing member reproduce only the optical disc of which type is discriminated by the discriminating device. Thus, only discriminated optical discs are reproduced, and undiscriminated optical discs are not reproduced.

Further, the regulating device may make the reproducing member reproduce only the region of which type is discriminated when at least two regions to be reproduced respectively by the laser oscillators having different wavelengths are overlapped with each other. Thus, the optical disc is at least partially reproduced, and user-friendliness is improved.

Further, according to an optical disc discriminating method for discriminating a plurality of types of optical discs according to an embodiment of the present invention, in a discriminating step, a type of the optical disc is discriminated from among a plurality of types of the optical discs based on a reflected light signal of a laser beam applied from any one of a plurality of laser oscillators having different wavelengths to the optical disc, or judged unable to discriminate the type of the optical disc and in a re-discriminating step, the discrimination or the judgment is performed based on a reflected light signal of a laser beam applied from another laser oscillator different from the one laser oscillator. Thus, when the optical disc is discriminated with the first laser oscillator, only one laser oscillator can be used. Even when the optical disc is not discriminated with the first laser oscillator, the optical disc is discriminated with one of the other laser oscillator. Therefore, this discrimination is faster than discrimination with sequential applications of laser oscillators corresponding to respective optical discs.

Further, the optical disc discriminating method may be used in a computer as an optical disc discriminating program. Thus, because the optical disc discriminating method is performed by the computer as a computer program, versatility of the optical disc discriminating method is improved.

Further, a recording medium readable by a computer may store the optical disc discriminating program. Thus, the optical disc discriminating program can be distributed not only by embedding in a device.

### FIRST EMBODIMENT

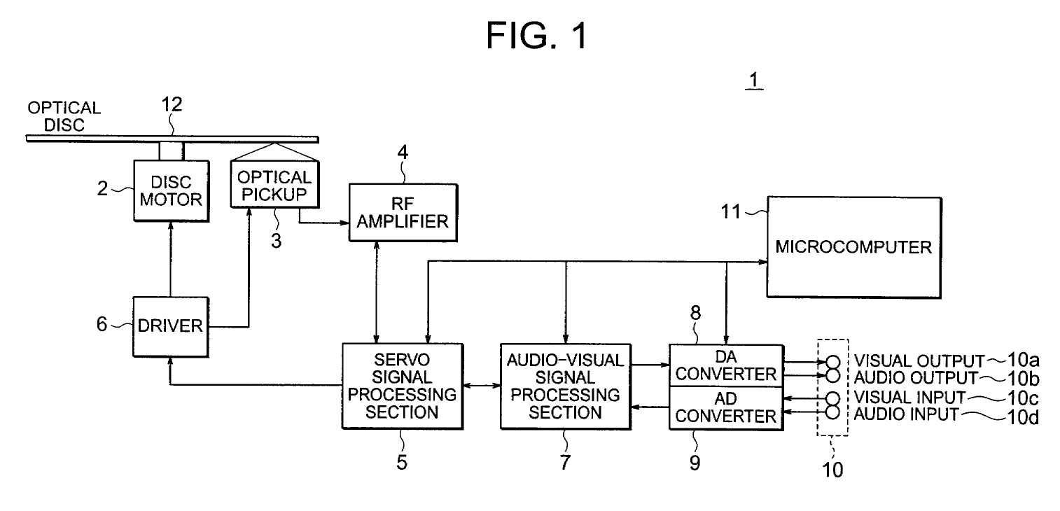

A multi disc player 1 as a reproducing device including an optical disc discriminating device according to a first embodiment of the present invention will be explained with reference to FIGS. 1 to 5. The multi disc player 1 can record and reproduce data on BD, DVD, and CD. As shown in FIG. 1, the multi disc player 1 includes a disc motor 2, an optical pickup 3, an RF amplifier 4, a servo signal processing section 5, a driver 6, an audio-visual signal processing section 7, a D/A converter 8, an A/D converter 9, an input-output terminals 10, and a microcomputer 11. Further, as an optical disc 12, any one of DVD, BD, or CD and an optical disc having regions of two types of DVD, BD, or CD overlapped with each other can be used.

The disc motor 2 is configured by such as a spindle motor for rotating the optical disc 12 mounted on the multi disc player 1.

The optical pickup 3 includes respective laser diodes having CD, DVD, BD wavelengths as not-shown laser oscillators for generating light beams applied to the optical disc 12, a lens for applying the laser beam to the optical disc 12, an actuator for focusing and tracking, and a photo receiver 30 for receiving the light beam reflected from the optical disc 12. The optical pickup 3 generates and outputs a focus error signal and a total returned light signal from an output of the photo receiver 30.

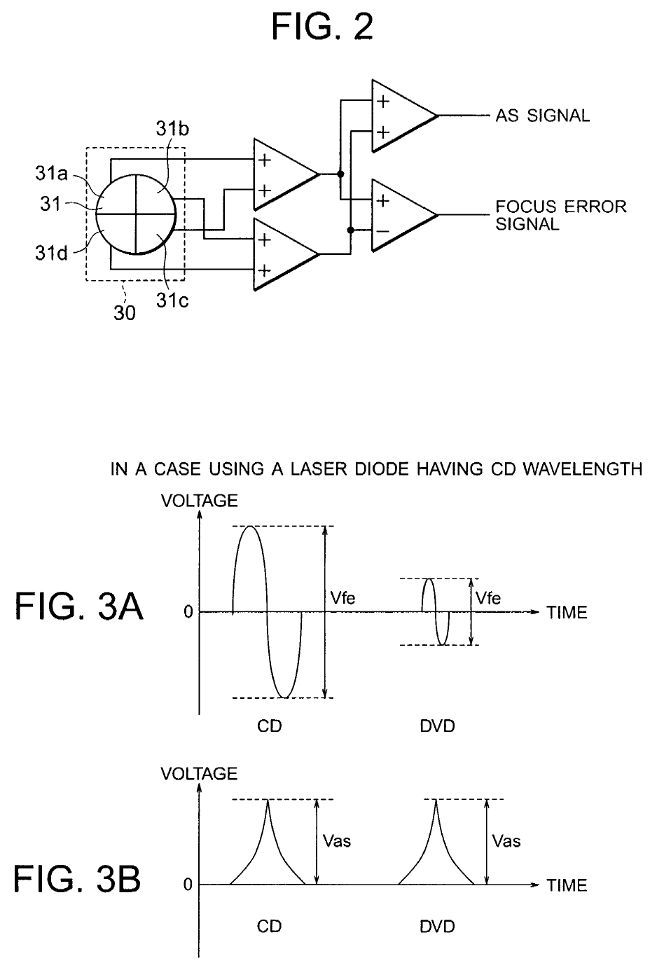

As shown in FIG. 2, the photo receiver 30 is composed of a tetrameric photo receiver 31. The tetrameric photo receiver 31 is composed of photo receiving surfaces 31a, 31b, 31c, and 31d.

The focus error signal is generated by subtracting a sum of outputs of the photo receiving surfaces 31b, 31d disposed in a diagonal position from a sum of outputs of the photo receiving surfaces 31a, 31c disposed in the other diagonal position (namely, (31a+31c)-(31b+31d)). A waveform of the focus error signal is shown in FIG. 3(a). The total returned light signal (AS signal) is generated by summing the outputs of the all photo receiving surfaces 31a, 31b, 31c, 31d of the tetrameric photo receiver 31. A waveform of the AS signal is shown in FIG. 3(b).

The RF amplifier 4 amplifies the signal outputted from the optical pickup 3 to a specific value, and outputs to the servo signal processing section 5.

The servo signal processing section 5 as a measuring device, a discriminating device, a controlling device, and a regulating device is incorporated with CPU (Central Processing Unit), RAM (Random Access Memory), and RAM (Read Only Memory). The servo signal processing section 5 discriminates the optical disc 12 based on an inputted signal from the RF amplifier 4, and controls the focus and tracking of the optical pickup 3 according to a control program stored in the ROM to allow data recorded on the optical disc 12 to be read correctly. Further, the servo signal processing section 5 converts a signal including music and video data recorded on the optical disc 12 from analog to digital, and outputs to the audio-visual signal processing section 7.

The driver 6 amplifies the signal inputted from the servo signal processing section 5, and outputs to the disc motor 2 and the optical pickup 3.

The audio-visual signal processing section 7 as a reproducing device demodulates the signal inputted from the servo signal processing section 5 into audio or visual signal, and corrects errors. Then, the audio-visual signal processing section 7 outputs to the D/A converter 8. Further, the audio-visual signal processing section 7 encodes the audio or visual signal inputted from the A/D converter 9 into a format for recording on the optical disc 12, and outputs to the servo signal processing section 5.

The D/A converter 8 converts the digital signal inputted from the audio-visual signal processing section 7 into the analog signal, and outputs via a video output 10a and an audio output 10b.

The A/D converter 9 converts the audio and video signals inputted from an audio input 10d and a video input 10c into digital signals, and outputs to the audio-visual signal processing section 7.

The microcomputer 11 totally controls inserting, ejecting, recording, reproducing operations of the optical disc 12 in the multi disc player 1.

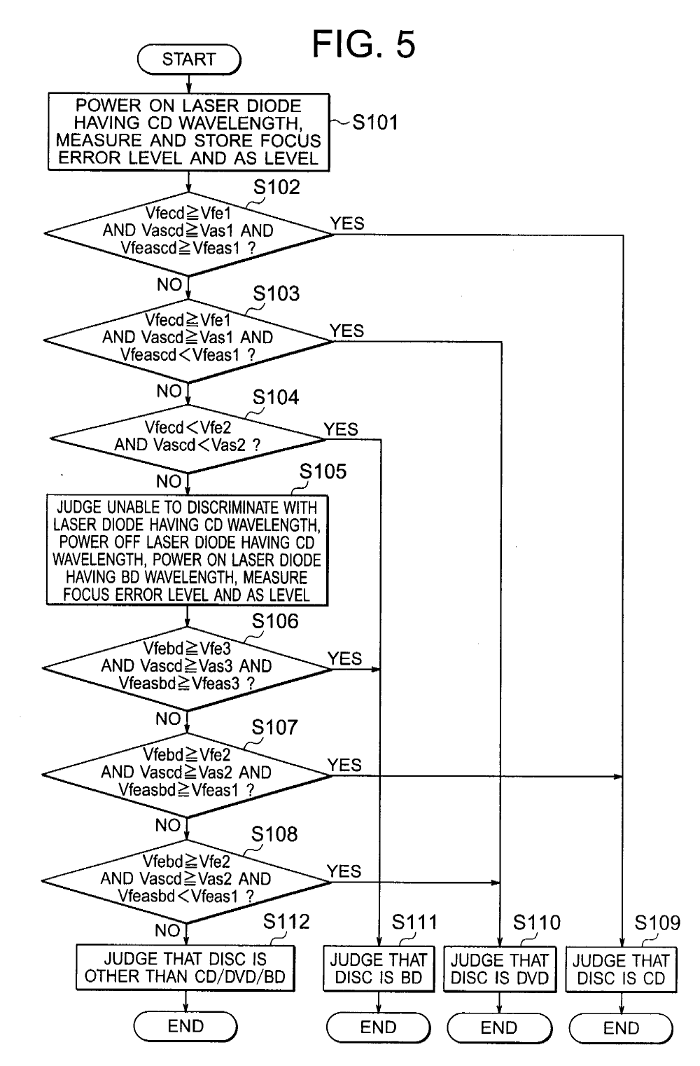

Next, in the multi disc player 1 having a structure shown in FIG. 1, a discriminating operation of the optical disc 12 will be explained with reference to a flowchart shown in FIG. 5. The flowchart shown in FIG. 5 is realized when the CPU in the servo signal processing section 5 runs the control program stored in the ROM in the servo signal processing section 5.

According to the first embodiment, in steps S102 to S104 shown in FIG. 5, the optical disc 12 is discriminated among a plurality of types of the optical discs, namely, DVD, BD, or CD using a laser diode having CD wavelength as a laser oscillator. A focus error signal level (Vfe in FIG. 3(a)) as a value from a plus peak value to a minus peak value of the focus error signal as a measured reflected light signal of the optical disc 12, an AS signal level (Vas in FIG. 3(b)) as a peak value of the AS signal, and a ratio (Vr) of these signal levels are used for performing the discrimination. Because ranges of the signal levels and the ratio are determined corresponding to the types of the optical discs, the signal levels and the ratio are used for the discrimination.

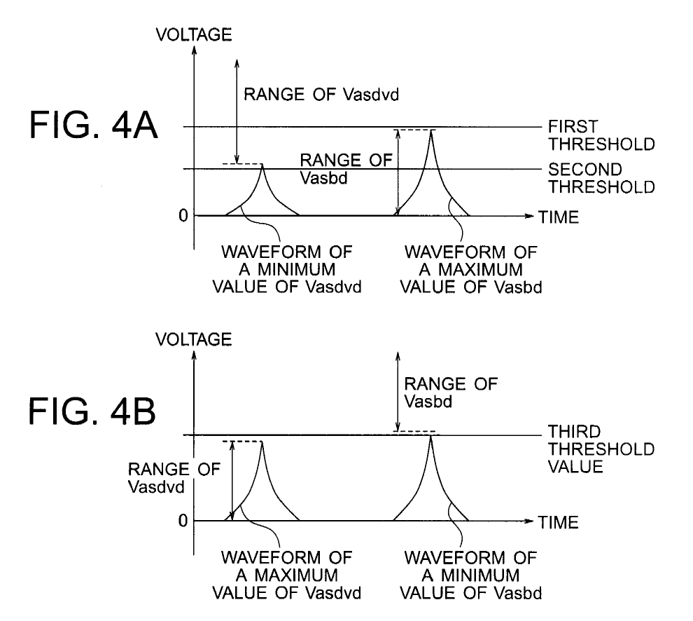

The minimum value of the focus error signal level and the AS signal level of DVD and CD with the laser diode having the CD wavelength may be smaller than the maximum value of the focus error signal level and the AS signal level of BD. FIG. 4(a) shows a relationship between the DVD minimum value and the BD maximum value in a case of the AS signals. In each of the focus error signal level and the AS signal level, a first threshold value corresponding to an upper limit of an overlapped range where ranges of DVD, CD, and BD are overlapped with each other, and a second threshold value corresponding to a lower limit of the overlapped range are set. Here, the first threshold value corresponding to the upper limit of the overlapped range is a little larger than the upper limit and is able to surely discriminate DVD or CD from BD. The second threshold value corresponding to the lower limit of the overlapped range is a little smaller than the lower limit and is able to discriminate BD from DVD and CD. Namely, when the signal level is larger than the first threshold value, the optical disc 12 is discriminated as DVD or CD, and when the signal level is smaller than the second threshold value, the optical disc 12 is discriminated as BD. FIG. 4(a) shows the first and second threshold values in the case of the AS signals. The same applies to the focus error signals.

In a case of discriminating between DVD and CD, as shown in FIG. 3, the AS signal levels of DVD and CD with the laser diode having the CD wavelength are substantially the same, but the focus error signal level of DVD is generally smaller than that of CD. Therefore, in each of DVD and CD, a ratio of the focus error signal level to the AS signal level as a ratio of one signal to another signal is calculated. The reason why the ratio of both signals is used is because when the laser diode having the CD wavelength is used, the focus error signal level of DVD may be increased and nearly equal to that of CV due to variation, however, in this case, the AS signal level is also increased, and the ratio of both signal levels of DVD is in a specific range and never in a range of a ratio of both signal levels of CD. Namely, ranges of the ratios of the focus error signal level to the AS signal level of DVD and CD are not overlapped with each other. Therefore, the ratio of measured signal levels is compared with a predetermined third threshold vale. If the ratio is less than the third threshold value, the measured optical disc is discriminated as DVD, and if the ratio is more than the third threshold value, the measured optical disc is discriminated as CD. Namely, in the operations described above, when the ranges of any of the signals and the ratio measured upon applying the laser beam from one laser oscillator to the optical disc are not overlapped with each other, the optical disc is discriminated based on the signals or the ratio (step S102 to S104).

When using the laser diode having the CD wavelength, sometimes the focus error signal levels or the AS signal levels of low reflectivity DVD, CD or a part of BD are close to each other. Namely, the ranges of the signals and the ratios measured upon an application of the laser beam from one laser oscillator sometimes are overlapped with each other. In this case, because the optical disc is not discriminated with the laser diode having the CD wavelength, the optical disc is judged unable to discriminate with the laser diode having the CD wavelength, and the laser diode having the BD wavelength as another laser oscillator different from the one laser oscillator is used. As shown in FIG. 4(b), with the laser diode having the BD wavelength, when the optical disc to be discriminated is BD, because the ranges of the focus error signal level, the AS signal level, and the ratio of the focus error signal level to the AS signal level of BD are not overlapped with those of DVD or CD, and are surely more than a specific value, the specific value as a third threshold value can be used for judging whether the optical disc is BD or not (step S106).

When the optical disc is discriminated not to be BD with the laser diode having the BD wavelength, the optical disc is discriminated by the previously measured focus error signal level and the previously measured AS signal level with the laser diode having the CD wavelength. At this time, there is no possibility that the optical disc is BD, the second threshold value which is smaller than the minimum value of DVD and CD is used. When the focus error signal level and the AS signal level are more than the second threshold value, the optical disc is discriminated as DVD or CD. When the signal level and the AS signal level are less than the second threshold level, the optical disc is discriminated not to be any one of DVD, BD and CD. The discrimination between DVD and CD is performed by the ratio of the focus error signal level and the AS signal level (step S107, S108).

Next, the operations described above will be explained in detail with reference to a flowchart shown in FIG. 5.

First, in step S101 as the measuring device, the laser diode having the CD wavelength as the one laser oscillator is powered on, the laser beam thereof applied to the optical disc 12, and the servo signal processing section 5 measures the focus error signal level Vfecd and the AS signal level Vascd from the reflected light of the light beam, and the measured values are stored in the RAM of the servo signal processing section 5. Then, the process goes to step S102.

Next, in step S102 as the discriminating device and the discriminating step, the CPU of the servo signal processing section 5 compares the first threshold value Vfe1 of the focus error signal level using the laser diode for CD as the first threshold value previously stored in the ROM of the servo signal processing section 5 with the focus error signal level Vfecd measured at the step S101. Similarly, the CPU compares the first threshold value Vas1 of the AS signal level previously stored in the ROM with the AS signal level Vascd measured at the step S101, and compares the threshold value Vfeas1 of the ratio of the focus error signal level to the AS signal level previously stored in the ROM with the ratio Vfeascd of the focus error signal level to the AS signal level measured at the step S101. Then, the CPU judges that the relationship of Vfecd≧Vfe1 and Vascd≧Vas1 and Vfeascd≧Vfeas1 is realized or not. When this relationship is realized (“YES”), the process goes to step S109. When this relationship is not realized (“NO”), the process goes to step S103. In this step (step S102), for discriminating the CD optical disc from DVD and BD, the CPU judges whether the measured focus error signal level and the measured AS signal level are values that a BD optical disc cannot attain or not (namely, the CPU judges whether these signal levels are more than the first threshold values out of the range where signals of CD and BD overlap with each other: Vfecd≧Vfe1 and Vascd≧Vas1). Further, the CPU judges whether the ratio of these signals is a value that a VDV optical disc cannot attain or not (namely, the CPU judges that the value is more than the third threshold value to discriminate the range when the ratios of CD and DVD are not overlapped with each other: Vascd≧Vas1). Thus, the CPU judges whether the optical disc 12 is CD or not.

Next, in step S103 as the discriminating device and the discriminating step, similar to the step S102, the CPU of the servo signal processing section 5 compares the first threshold value Vfe1 of the focus error signal level previously stored in the ROM of the servo signal processing section 5 with the focus error signal level Vfecd measured at the step S101. Also, the CPU compares the first threshold value Vas1 of the AS signal level with the AS signal level Vascd, and compares the threshold value Vfeas1 of the ratio of the focus error signal level to the AS signal level with the ratio Vfeascd of the focus error signal level to the AS signal level. Then, the CPU judges that the relationship of Vfecd≧Vfe1 and Vascd≧Vas1 and Vfeascd<Vfeas1 is realized or not. When this relationship is realized (“YES”), the process goes to step S110. When this relationship is not realized (“NO”), the process goes to step S104. In this step (step S103), for discriminating the DVD optical disc from CD and BD, the CPU judges whether the measured focus error signal level and the measured AS signal level are values that the BD optical disc cannot attain or not (namely, the CPU judges whether these signal levels are more than the first threshold values out of the range where signals of DVD and BD overlap with each other: Vfecd≧Vfe1 and Vascd≧Vas1). Further, the CPU judges whether the ratio of these signals is a value that the CD optical disc cannot attain or not (namely, the CPU judges that the value is more than the third threshold value to discriminate the range when the ratios of CD and DVD are not overlapped with each other: Vfeascd<Vfeas1). Thus, the CPU judges whether the optical disc 12 is DVD or not.

Next, in step S104 as the discriminating device and the discriminating step, the CPU of the servo signal processing section 5 compares the second threshold value Vfe2 of the focus error signal level previously stored in the ROM of the servo signal processing section 5 as the first threshold value using the laser diode having the CD wavelength with the focus error signal level Vfecd measured at the step S101. Also, the CPU compares the second threshold value Vas2 of the AS signal level with the AS signal level Vascd. Then, the CPU judges that the relationship of Vfecd<Vfe2 and Vascd<Vas2 is realized or not. When this relationship is realized (“YES”), the process goes to step S111. When this relationship is not realized (“NO”), the process goes to step S105. In this step (step S104), for discriminating the BD optical disc from CD and DVD, the CPU judges whether the measured focus error signal level and the measured AS signal level are values that signals of CD or DVD cannot attain or not (namely, the CPU judges whether these signal levels are less than the second threshold values out of the range where signals of DVD and BD or signals of BD and DVD overlap with each other: Vfecd<Vfe2 and Vascd<Vas2). Thus, the CPU judges whether the optical disc 12 is BD or not.

Next, in step S105 as the measuring device and the discriminating step, the laser diode having the CD wavelength is powered off, the laser diode for BD as another laser oscillator is powered on, and applies the laser beam to the optical disc 12. Then, the servo signal processing section 5 measures the focus error signal level Vfebd and the AS signal level Vasbd from the reflected light of the laser beam, and the process goes to step S106.

Next, in step S106 as the discriminating device and the re-discriminating step, the CPU of the servo signal processing section 5 compares the third threshold value Vfe3 of the focus error signal level using the laser diode having the BD wavelength previously stored in the ROM of the servo signal processing section 5 with the focus error signal level Vfebd measured at the step S105. Similarly, the CPU compares the third threshold value Vas3 of the AS signal level previously stored in the ROM with the AS signal level Vasbd measured at the step S101, and compares the threshold value Vfeas3 which is the ratio of the focus error signal level to the AS signal level previously stored in the ROM with the ratio Vfeasbd of the focus error signal level to the AS signal level measured at the step S105. Then, the CPU judges that the relationship of Vfebd≧Vfe3, Vasbd≧Vas3 and Vfeasbd≧Vfeas3 is realized or not. When this relationship is realized (“YES”), the process goes to step S107. When this relationship is not realized (“NO”), the process goes to step S107. In this step (step S106), the CPU judges whether the levels and the ratio are more than the threshold value using the laser diode having BD wavelength (the third threshold value) or not, namely, the CPU judges whether the optical disc 12 is BD or not.

Next, in step S107 as the discriminating device and the discriminating step, the CPU respectively compares the focus error signal level Vfecd and the AS signal level Vascd measured with the laser diode having the CD wavelength and stored in the RAM of the servo signal processing section 5 at the step S101 with the first threshold values. Then, the CPU judges that the relationship of Vfecd≧Vfe2, Vascd≧Vas2 and Vfeascd≧Vfeas1 is realized or not. When this relationship is realized (“YES”), the process goes to step S109. When this relationship is not realized (“NO”), the process goes to step S108. In this step (step S107), the CPU judges whether the levels and the ratio are more than the second threshold values and more than the threshold value of the ratio of the focus error signal level to the AS signal level or not, namely, the CPU judges whether the optical disc 12 is CD or not.

Next, in step S108 as the discriminating device and the discriminating step, similar to the step S107, the CPU respectively compares the focus error signal level Vfecd and the AS signal level Vascd measured with the laser diode for CD and stored in the RAM of the servo signal processing section 5 with the first threshold values. Then, the CPU judges that the relationship of Vfecd≧Vfe2, Vascd≧Vas2 and Vfeascd<Vfeas1 is realized or not. When this relationship is realized (“YES”), the process goes to step S110. When this relationship is not realized (“NO”), the process goes to step S112. In this step (step S108), the CPU judges whether the levels and the ratio are more than the second threshold values and less than the threshold value of the ratio of the focus error signal level to the AS signal level or not, namely, the CPU judges whether the optical disc 12 is DVD or not.

In step S109, the optical disc 12 is discriminated as CD, and the reproducing and recording are performed with the laser diode for CD. Namely, in a case of reproducing, data recorded on CD is readout through the optical pickup 3, and demodulated into the audio signal by the audio-visual signal processing section 7 via the RF amplifier 4 and the servo signal processing section 5. Then, the signal is converted to the analog signal by the D/A converter 8, and outputted via the audio output 10b. In a case of recording, the audio inputted from the audio input 10d is converted to the digital signal by the A/D converter 9, and encoded into a format for recording on CD by the audio-visual signal processing section 7. Then, the encoded data is outputted to the servo signal processing section 5 and recorded on CD via the RF amplifier 4 and the optical pickup 3.

In step S110, the optical disc 12 is discriminated as DVD, and the reproducing and recording are performed with the laser diode for DVD. Namely, in a case of reproducing, data recorded on DVD is readout through the optical pickup 3, and demodulated into audio and visual signals by the audio-visual signal processing section 7 via the RF amplifier 4 and the servo signal processing section 5. Then, the signals are converted to the analog signal by the D/A converter 8, and outputted via the video output 10a and the audio output 10b. In a case of recording, the video and audio inputted from the video input 10c and the audio input 10d are converted to the digital signal by the A/D converter 9, and encoded into a format for recording on DVD by the audio-visual signal processing section 7. Then, the encoded data is outputted to the servo signal processing section 5 and recorded on DVD via the RF amplifier 4 and the optical pickup 3.

In step S111, the optical disc 12 is discriminated as BD, and the reproducing and recording are performed with the laser diode for BD. Namely, in a case of reproducing, data recorded on BD is readout through the optical pickup 3, and demodulated into audio and visual signals by the audio-visual signal processing section 7 via the RF amplifier 4 and the servo signal processing section 5. Then, the signals are converted to the analog signal by the D/A converter 8, and outputted via the video output 10a and the audio output 10b. In a case of recording, the video and audio inputted from the video input 10c and the audio input 10d are converted to the digital signal by the A/D converter 9, and encoded into a format for recording on BD by the audio-visual signal processing section 7. Then, the encoded data is outputted to the servo signal processing section 5 and recorded on BD via the RF amplifier 4 and the optical pickup 3.

In step S112, the optical disc 12 is discriminated as none of CD, DVD or BD. The recording or the reproducing is not performed and the process goes to the end.

According to this embodiment, when discriminating the optical disc 12 set on the multi disc player 1, firstly, the focus error signal level Vfecd and the AS signal level Vascd are measured with the laser diode having the CD wavelength. If the signal levels are respectively more than the first threshold values (Vfe1, Vas1), the optical disc 12 is correctly discriminated as DVD or CD. In the discrimination between DVD and CD, if the ratio Vfe/Vas of the focus error signal level to the AS signal level is less than the specific threshold value Vfeas1, the optical disc 12 is discriminated as DVD. If the ratio is over the specific threshold value Vfeas1, the optical disc 12 is discriminated as CD. Further, if the focus error signal level Vfecd and the AS signal level Vascd are respectively less than the second threshold values (Vfe2, Vas2), the optical disc 12 is correctly discriminated as BD. When the optical disc 12 cannot be discriminated with the laser diode for CD, namely, when the focus error signal level or the AS signal level is less than the first threshold value, and more than the second threshold value (when the signal level is in the overlapped range), the laser diode for CD is exchanged for the laser diode having the BD wavelength. Because in a case of BD, the signals and the ratio are not in the overlapped range, when the signals and the ratio are over the threshold value of BD (the third threshold value Vfe3), the optical disc 12 is correctly discriminated as BD. Thus, discriminating the optical disc 12 in this way is faster than using the three types of laser diodes sequentially and more correct than using only one threshold value.

Incidentally, in this embodiment, the laser diode having the CD wavelength is firstly powered on, however, the laser diode having the DVD wavelength may be firstly powered on. In this case, threshold values and the inequality signs are adapted to the laser diode having the DVD wavelength.

### SECOND EMBODIMENT

Next, the multi disc player 1 as the reproducing device having the optical disc discriminating device according to a second embodiment of the present invention will be explained with reference to FIGS. 1, 6, and 7. Incidentally, for some elements same with those of the first embodiment, same reference numerals are used and explanations are omitted.

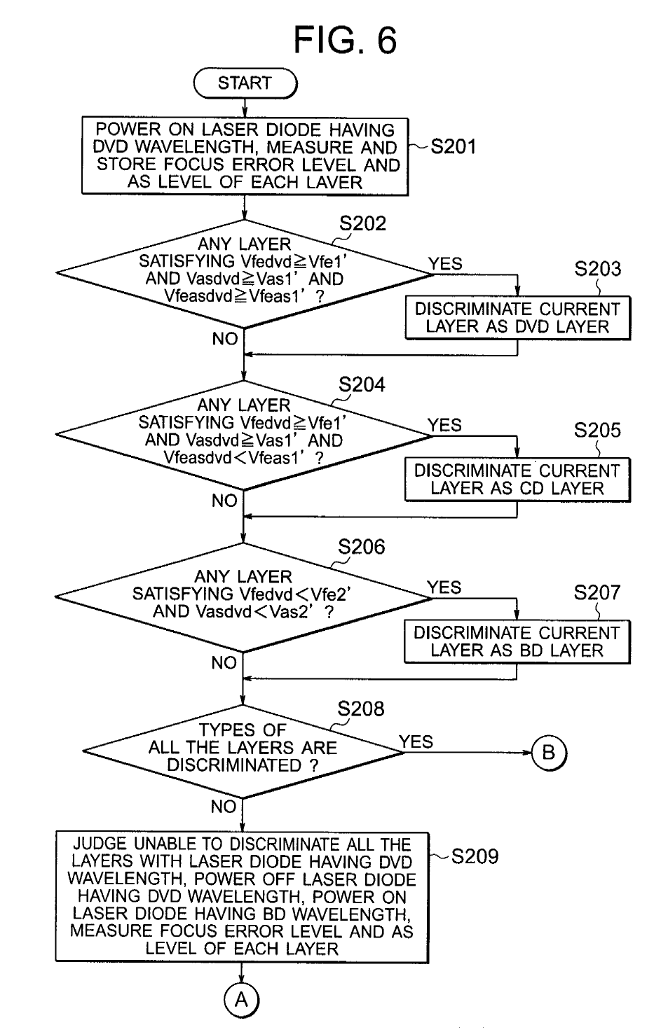

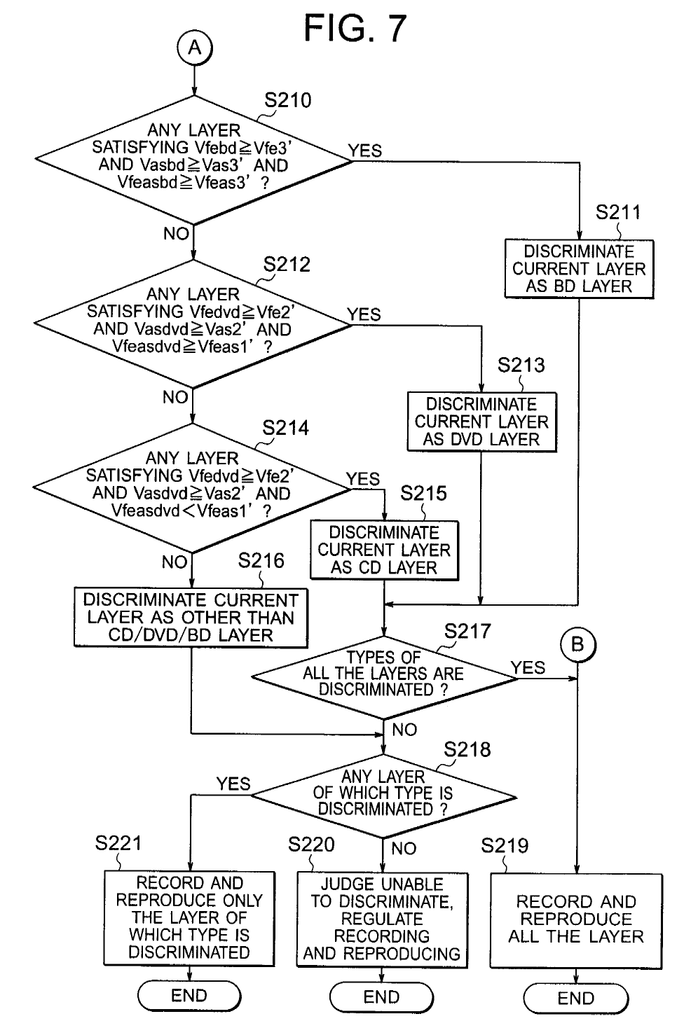

The structure of the multi disc player 1 according to this embodiment is substantially same as that of the first embodiment, however, in the second embodiment, a hybrid disc in which two layers of DVD, BD, and CD are overlapped with each other can be used for recording and reproducing. Hereafter, a discriminating operation for each layer on the hybrid disc will be explained with reference to a flowchart shown in FIGS. 6 and 7. Similar to the first embodiment, the flowchart shown in FIGS. 6 and 7 is realized by an execution of the control program stored in the ROM of the servo signal processing section 5 by the CPU of the servo signal processing section 5.

The discrimination method is basically the same as that in the first embodiment, however, the discriminating method shown in the first embodiment is applied to each of the two layers.

Firstly, in step S201 as the measuring device, the laser diode having the DVD wavelength is powered on, and the laser beam thereof is applied to the optical disc 12. Then, the servo signal processing section 5 measures the focus error signal level Vfedvd and the AS signal level Vasdvd of each layer from the reflected light, and the RAM of the servo signal processing section 5 stores the measured values of each level of each layer. Then, the process goes to step S202.

Next, in step S202 as the discriminating device, the CPU of the servo signal processing section 5 compares the first threshold value Vfe1′ of the focus error signal level using the laser diode for DVD as the first threshold value previously stored in the ROM of the servo signal processing section 5 with the focus error signal level Vfedvd of each layer measured at the step S201. Similarly, the CPU compares the first threshold value Vas1′ of the AS signal level previously stored in the ROM with the AS signal level Vasdvd of each layer measured at the step S201, and compares the threshold value Vfeas1′ of the ratio of the focus error signal level to the AS signal level previously stored in the ROM with the ratio Vfeasdvd of the focus error signal level to the AS signal level of each layer measured at the step S201. Then, the CPU judges that the relationship of Vfedvd≧Vfe1′, Vasdvd≧Vas1′ and Vfeasdvd≧Vfeas1′ is realized or not. When this relationship is realized (“YES”), the process goes to step S203. When this relationship is not realized (“NO”), the process goes to step S204. In this step (step S202), the CPU judges whether the focus error signal and the AS signal are equal to or more than the first threshold values out of the range overlapped with the signal of BD, and the ratio of the focus error signal level to the AS signal level is more than the third threshold value where the ratios of signals of DVD and CD are not overlapped with each other, namely, the CPU judges whether this layer is a DVD layer or not.

In step S203, the current layer is discriminated as the DVD layer, and the discriminating result is stored in the RAM. Then, the process goes to step S204.

Next, in step S204 as the discriminating device and the discriminating step, similar to the step S202, the CPU of the servo signal processing section 5 compares the first threshold value Vfe1′ of the focus error signal level previously stored in the ROM of the servo signal processing section 5 with the focus error signal level Vfedvd measured at the step S201. Also, the CPU compares the first threshold value Vas1′ of the AS signal level with the AS signal level Vasdvd, and compares the threshold value Vfeas1′ of the ratio of the focus error signal level to the AS signal level with the ratio Vfeasdvd of the focus error signal level to the AS signal level. Then, the CPU judges that the relationship of Vfedvd≧Vfe1′, Vasdvd≧Vas1′ and Vfeasdvd<Vfeas1′ is realized or not. When this relationship is realized (“YES”), the process goes to step S205. When this relationship is not realized (“NO”), the process goes to step S206. In this step (step S204), the CPU judges whether the focus error signal and the AS signal are equal to or more than the first threshold values, namely, the signals are out of the range where the signals of BD are overlapped, and the ratio of the focus error signal level to the AS signal level is less than the third threshold value, namely, the ratio of DVD is not overlapped with the ratio of CD, or not. Namely, the CPU judges whether the current layer is a CD layer or not.

In step S205, the current layer is discriminated as the CD layer, and the discriminating result is stored in the RAM. Then, the process goes to step S206.

Next, in step S206 as the discriminating device and the discriminating step, the CPU of the servo signal processing section 5 compares the second threshold value Vfe2′ of the focus error signal level previously stored in the ROM of the servo signal processing section 5 as the first threshold value using the laser diode having the CD wavelength with the focus error signal level Vfedvd of each layer measured at the step S201. Also, the CPU compares the second threshold value Vas2′ of the AS signal level with the AS signal level Vasdvd of each layer. Then, the CPU judges that the relationship of Vfedvd<Vfe2′ and Vasdvd<Vas2′ is realized or not. When this relationship is realized (“YES”), the process goes to step S207. When this relationship is not realized (“NO”), the process goes to step S208. In this step (step S206), the CPU judges whether the measured focus error signal level and the measured AS signal level are less than the second threshold values, namely, the signals are out of the range where the signals of DVD and CD are overlapped with the signal of BD, or not. Namely, the CPU judges whether the current layer is BD or not.

In step S207, the current layer is discriminated as the BD layer, and the discriminating result is stored in the RAM. Then, the process goes to step S208.

Next, in step S208, whether all the layers are discriminated or not is judged. When all the layers are discriminated (“YES”), the process goes to step S219. When all the layers are not discriminated (“NO”), the process goes to step S209.

Next, in step S209 as the measuring device, the laser diode having the DVD wavelength is powered off, the laser diode for BD as another laser oscillator is powered on, and applies the laser beam to the optical disc 12. Then, the servo signal processing section 5 measures the focus error signal level Vfebd′ and the AS signal level Vasbd′from the reflected light of the laser beam with respect to the layer which has not been discriminated, and the process goes to step S210.

Next, in step S210 as the discriminating device and the re-discriminating step, the CPU of the servo signal processing section 5 compares the third threshold value Vfe3′ of the focus error signal level using the laser diode having the BD wavelength previously stored in the ROM of the servo signal processing section 5 with the focus error signal level Vfebd′ of each layer measured at the step S209. Similarly, the CPU compares the third threshold value Vas3′ of the AS signal level previously stored in the ROM with the AS signal level Vasbd′ of each layer measured at the step S209, and compares the threshold value Vfeas3′ which is the ratio of the focus error signal level to the AS signal level previously stored in the ROM with the ratio Vfeasbd′ of the focus error signal level to the AS signal level of each layer measured at the step S209. Then, the CPU judges that the relationship of Vfebd′≧Vfe3′, Vasbd′≧Vas3′ and Vfeasbd′≧Vfeas3′ is realized or not. When this relationship is realized (“YES”), the process goes to step S211. When this relationship is not realized (“NO”), the process goes to step S212. In this step (step S210), the CPU judges whether the levels and the ratio are more than the threshold value using the laser diode having the BD wavelength or not, namely, the CPU judges whether the current layer is BD or not.

In step S211, the current layer is discriminated as the BD layer, and the discriminating result is stored in the RAM. Then, the process goes to step S217.

Next, in step S212 as the discriminating device and the discriminating step, the CPU respectively compares the focus error signal level Vfedvd and the AS signal level Vasdvd measured with the laser diode having the DVD wavelength and stored in the RAM of the servo signal processing section 5 at the step S201 with the first threshold values. Then, the CPU judges that the relationship of Vfedvd≧Vfe2′, Vasdvd≧Vas2′ and Vfeasdvd≧Vfeas1′ is realized or not. When this relationship is realized (“YES”), the process goes to step S213. When this relationship is not realized (“NO”), the process goes to step S214. In this step (step S212), the CPU judges whether the levels and the ratio are more than the first threshold values and more than the threshold value of the ratio of the focus error signal level to the AS signal level or not, namely, the CPU judges whether the current layer is the DVD layer or not.

In step S213, the current layer is discriminated as the DVD layer, and the discriminating result is stored in the RAM. Then, the process goes to step S217.

Next, in step S214 as the discriminating device and the discriminating step, similar to the step S212, the CPU respectively compares the focus error signal level Vfedvd and the AS signal level Vasdvd measured with the laser diode for DVD and stored in the RAM of the servo signal processing section 5 with the first threshold values. Then, the CPU judges that the relationship of Vfedvd≧Vfe2′, Vasdvd≧Vas2′ and Vfeasdvd<Vfeas1′ is realized or not. When this relationship is realized (“YES”), the process goes to step S215. When this relationship is not realized (“NO”), the process goes to step S216. In this step (step S214), the CPU judges whether the levels and the ratio are more than the first threshold values and less than the threshold value of the ratio of the focus error signal level to the AS signal level or not, namely, the CPU judges whether the current layer is the CD layer or not.

In step S215, the current layer is discriminated as the CD layer, and the discriminating result is stored in the RAM. Then, the process goes to step S217. In step S216, the current layer is discriminated as a layer other than DVD, BD, or CD, and the discriminating result is stored in the RAM. Then, the process goes to S218.

Next, in step S217, whether all of the layers are discriminated or not is judged based on the discriminating results stored in the RAM. When all the layers are discriminated (“YES”), the process goes to step S219. When all the layers are not discriminated (“NO”), the process goes to step S218.

Next, in step S218, whether at least one layer is discriminated or not is judged. When at least one layer is discriminated (“YES”), the process goes to step S221. When no layer is discriminated (“NO”), the process goes to step S220.

In step S219, because all the layers are discriminated, all the layers are recorded or reproduced.

In step S220 as the regulating device, the optical disc 12 is discriminated as an unknown disc and prevented from being recorded or reproduced. In step S221 as the regulating device, only the discriminated layers are recorded or reproduced.

According to this embodiment, the multi disc player 1 can discriminate each layer of the hybrid disc, on which two layers of DVD, BD, or CD are laminated, faster than the discrimination sequentially using three laser diodes, and more correctly than the discrimination using only one threshold value. Further, only the layers of which types are discriminated can be recorded or reproduced. Further, when no layer is discriminated, the optical disc 12 can be regulated to be prevented from being recorded or reproduced.

Incidentally, in this embodiment, the laser diode having the DVD wavelength is firstly powered on, however, the laser diode having the CD wavelength may be firstly powered on similar to the first embodiment. In this case, threshold values and the inequality signs are adapted to the laser diode having the CD wavelength.

Further, in the first and second embodiments, the focus error signal and the AS signal are used for the discrimination of the optical disc 12. However, any signal generated from the reflected light from the optical disc 12 and of which signal level is varied corresponding to the type of the optical disc 12 such as an RF signal can be used.

Further, in the first and second embodiments, the discrimination of DVD, BD, and CD is performed. However, the present invention is not limited to there three types of optical discs, and the optical disc such as HD-DVD can be discriminated.

According to the embodiments described above, an optical disc discriminating device, an optical disc discriminating method, and an optical disc discriminating program can be attained.

(Note 1) A multi disc player 1 for discriminating DVD, BD, and CD comprising:

a plurality of laser oscillators having different wavelengths corresponding to DVD, BD, and CD;

a servo signal processing section 5 for measuring an focus error signal and an AS signal derived from the reflected light of a laser beam applied to an optical disc 12 by the laser oscillator having the CD wavelength from among the laser oscillators;

the servo signal processing section 5 for discriminating the type of the optical disc 12 from DVD, BD, or CD, or judging unable to discriminate based on the focus error signal and the AS signal measured by the servo signal processing section 5; and

the servo signal processing section 5 to make the servo signal processing section 5 perform said discrimination or said judgment, wherein when the servo signal processing section 5 judges unable to discriminate, the servo signal processing section 5 makes the laser oscillator having the BD wavelength different from the laser oscillator having the CD wavelength apply a laser beam to the optical disc 12, and makes the servo signal processing section 5 perform the discrimination or the judgment.

According to the multi disc player 1, when the optical disc is discriminated with the first laser oscillator, only one laser oscillator can be used. Even when the optical disc is not discriminated with the first laser oscillator, the optical disc is discriminated with one of the other laser oscillator. Therefore, this discrimination is faster than discrimination with sequential applications of laser oscillators corresponding to respective optical discs.

(Note 2) An optical disc discriminating method for discriminating a plurality of types of optical discs comprising:

a servo signal processing section 5 for discriminating a type of the optical disc 12 from among DVD, BD, and CD based on a focus error signal and an AS signal derived from a reflected light of a laser beam applied to the optical disc 12 from a laser oscillator having CD wavelength from among a plurality of laser oscillators having different wavelengths corresponding to DVD, BD, and CD, or judging unable to discriminate the type of the optical disc 12; and

the servo signal processing section 5 for making the laser oscillator having BD wavelength different from the laser oscillator having CD wavelength apply a laser beam to the optical disc 12 and performing said discrimination or said judgment when the servo signal processing section 5 judges unable to discriminate with the laser oscillator having CD wavelength.

According to this optical disc discriminating method, when the optical disc is discriminated with the first laser oscillator, only one laser oscillator can be used. Even when the optical disc is not discriminated with the first laser oscillator, the optical disc is discriminated with one of the other laser oscillator. Therefore, this discrimination is faster than discrimination with sequential applications of laser oscillators corresponding to respective optical discs.

Although the present invention has been fully described by way of example with reference to the accompanying drawings, it is to be understood that various changes and modifications will be apparent to those skilled in the art. Therefore, unless otherwise such changes and modifications depart from the scope of the present invention hereinafter defined, they should be construed as being included therein.

1. An optical disc discriminating device for discriminating a plurality of types of optical discs comprising:
a plurality of laser oscillators having different wavelengths corresponding to the types of optical discs;
a measuring device for measuring a reflected light signal of a laser beam applied to an optical disc by any one of the laser oscillators;
a discriminating device for discriminating the type of the optical disc from among the types of the optical discs, or judging unable to discriminate based on the signal measured by the measuring device; and
a controlling device to make the discriminating device perform said discrimination or said judgment,
wherein when the discriminating device judges unable to discriminate, the controlling device makes another laser oscillator different from the one oscillator apply a laser beam to the optical disc, and makes the discriminating device perform the discrimination or the judgment.

2. The optical disc discriminating device as claimed in claim 1,
wherein the measuring device measures a plurality of types of signals from the reflected light, and the discriminating device performs said discrimination or said judgment based on the types of signals and a ratio of one type to another type among the types of signals.

3. The optical disc discriminating device as claimed in claim 2,
wherein when reflected light signal ranges or the reflected light signal ratio ranges attained by applying the laser beam to any one of the optical discs by the one laser oscillator and by applying the laser beam to another optical disc different from the one optical disc by the one laser oscillator are overlapped, the controlling device previously stores a first threshold value corresponding to an upper limit of an overlapped range, and a second threshold value corresponding to a lower limit of the overlapped range, and when the ranges are not overlapped with each other, the controlling device previously stores a third threshold value to be used for discriminating the reflected light ranges, and
wherein the controlling device makes the discriminating device discriminate or judge using the first, second, and third threshold values.

4. The optical disc discriminating device as claimed in claim 3,
wherein the discriminating device discriminates the one type from the other types of the optical discs based on the reflected light signals or the ratios when either the reflected light signals or the ratios measured by the measuring device upon an application of the laser beam from the one laser oscillator are not in the overlapped range, and this discrimination is carried out with respect to each of the remaining optical discs.

5. The optical disc discriminating device as claimed in claim 3,
wherein the discriminating device judges unable to discriminate the type of the measured optical disc when all the reflected light signals and the ratios measured by the measuring device upon an application of the laser beam from the one laser oscillator is in the overlapped range.

6. The optical disc discriminating device as claimed in claim 2,
wherein the types of the signals at least include a focus error signal and a total returned light signal.

7. The optical disc discriminating device as claimed in claim 1,
wherein a plurality of reproducible regions which are to be reproduced by the respective laser oscillators are overlapped with each other on the optical disc, and
wherein the controlling device makes the one laser oscillator apply the laser beam to the regions of respective layers of the optical disc, and makes the discriminating device discriminate or judge the types of the respective layers based on the reflected light signals from the respective layers.

8. A reproducing device comprising a reproducing member for at least reproducing data of a plurality of types of the optical discs,
wherein the reproducing device further comprises the optical disc discriminating device as claimed in claim 1.

9. The reproducing device as claimed in claim 8,
wherein the optical disc discriminating device further includes a regulating device to make the reproducing member reproduce only the optical disc of which type is discriminated by the discriminating device.

10. The reproducing device as claimed in claim 9,
wherein the regulating device makes the reproducing member reproduce only the region of which type is discriminated when at least two regions to be reproduced respectively by the laser oscillators having different wavelengths are overlapped with each other.

11. An optical disc discriminating method for discriminating a plurality of types of optical discs comprising:
a discriminating step of discriminating a type of the optical disc from among a plurality of types of the optical discs based on a reflected light signal of a laser beam applied from any one of a plurality of laser oscillators having different wavelengths to the optical disc, or judging unable to discriminate the type of the optical disc; and
a re-discriminating step of performing said discrimination or said judgment based on a reflected light signal of a laser beam applied from another laser oscillator different from the one laser oscillator when the optical disc is judged unable to be discriminate at the discriminating step.

12. An optical disc discriminating program,
wherein a computer performs the optical disc discriminating method as claimed in claim 11.

13. A recording medium readable by a computer,
wherein the recording medium stores the optical disc discriminating program as claimed in claim 12.
